(19) United States
(12) Patent Application Publication
(10) Pub. No.: US 2025/0305583 A1
(43) Pub. Date: Oct. 2, 2025

(54) COMPOSITE SEAL FOR A MOTOR VEHICLE

(71) Applicant: BRUSS SEALING SYSTEMS GMBH, Hoisdorf (DE)

(72) Inventors: Manfred BRAND, Tremsbüttel (DE); Harald LEISNER, Bargteheide (DE); Stefan RUST, Hamburg (DE)

(21) Appl. No.: 19/081,496

(22) Filed: Mar. 17, 2025

(30) Foreign Application Priority Data
Mar. 28, 2024 (DE) 10 2024 001 010.6

(51) Int. Cl. F16J 15/02; F16J 15/00

(52) U.S. Cl. CPC F16J 15/027; F16J 15/002

(57) ABSTRACT

A composite seal for the circumferential sealing of an interior space, formed between two motor vehicle housing parts, against an exterior space has a metallic profile support and an elastomeric main seal which is connected to the profile support at an end face, facing the interior space, of the profile support. An additional elastomeric profile seal is connected to an exterior side, facing the exterior space, of the profile support, which profile seal causes a sealing against the outside.

### CROSS-REFERENCE TO RELATED APPLICATION

This application claims priority to German Patent Application No. 10 2024 001 010.6, filed on Mar. 28, 2024; which is incorporated in its entirety herein.

### FIELD OF THE INVENTION

The present invention relates to a composite seal for the circumferential sealing of an interior space, formed between two motor vehicle housing parts, against an exterior space, having a metallic profile support and an elastomeric main seal which is connected to the profile support at an end face, facing the interior space, of the profile support.

### BACKGROUND OF THE INVENTION

Unevenness and roughness in the sealing surface of the two housing parts promote the penetration of water between the profile support and the housing part. Due to the lower operating temperatures of electric drives compared to the operating temperatures of combustion engines, this water no longer evaporates and permanently promotes corrosion on housing parts and/or profile supports.

### BRIEF SUMMARY

The object of the invention is to provide a composite seal that reliably prevents corrosion on housing parts and/or profile supports.

The invention achieves this object by the features of the independent claims.

### DETAILED DESCRIPTION

According to the invention, an additional elastomeric profile seal is connected to an exterior side, facing the exterior space, of the profile support, which profile seal causes a sealing against the outside and effectively prevents the penetration of moisture into the gap between the profile support and the housing parts.

There is hardly any installation space left for the additional profile seal facing outwards because the sealing flange width of the housing parts is often limited, the profile support cannot be arbitrarily narrow for stability reasons, and the main seal should be as high as possible for reasons of aging resistance and is therefore connected to the inner end face of the profile support. Preferably, therefore, at least one recess is provided in the profile support on its exterior side, in which recess the additional profile seal is arranged. The recess or an embossing on the exterior side generates installation height for the additional profile seal. This allows a seal to be applied at or below the level of the profile support.

The additional profile seal facing outwards has only a protective function and can therefore be lower in height than the main seal. In other words, the height of the additional profile seal in the sealing direction is preferably lower than the height of the main seal.

In one embodiment, the additional profile seal has a sealing element on both sealing sides of the profile support. For manufacturing reasons, to facilitate the injection of elastomer, the additional profile seal can have an elastomer bridge running across the external end face of the profile support and connecting the sealing elements to one another; however, this is not absolutely necessary.

Preferably, the profile support has at least one, preferably two, embossed portions in a preferably elastomer-free region between the main seal and the additional profile seal.

By means of the embossed portion(s), which can be produced in particular by means of the injection-molding tool, additional relief space can be created for the main seal and/or the additional profile seal. Corresponding relief grooves in the main seal and/or in the additional profile seal may then be unnecessary.

In other embodiments, the main seal and/or the additional profile seal may have at least one relief groove.

Preferably, the circumferential profile support consists of several support parts which are connected to one another only by the elastomer of the main seal and/or the elastomer of the additional profile seal. This embodiment has the advantage that the ring-shaped profile support does not have to be punched as a whole, but only the individual support parts with a considerably smaller surface area, which saves considerable punching waste.

Preferably, a gap running between the support parts is non-linear, in particular S-shaped. For this purpose, the gap can have a central portion, running parallel to the ring axis or to the circumference of the profile support, and two end portions each extending in opposite directions from the central portion. This shape of the gap has the advantage that the connection between the support parts via the elastomer is stronger than with a linear gap.

### BRIEF DESCRIPTION OF THE FIGURES

The invention is explained below using preferred embodiments with reference to the accompanying figures, in which:

FIG. 1 is a schematic plan view of a composite seal from one sealing direction;

FIG. 2 is a cross-sectional view of a composite seal;

FIG. 3 is a cross-sectional view of a composite seal in an additional embodiment; and

FIG. 4 is a cross-sectional view of a composite seal mounted between two housing parts.

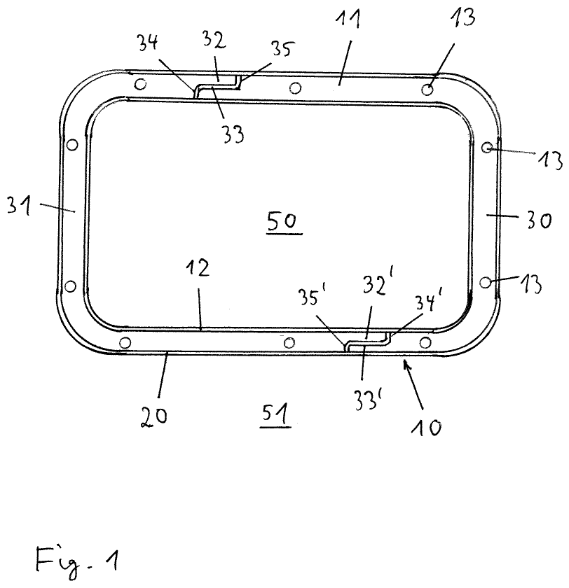

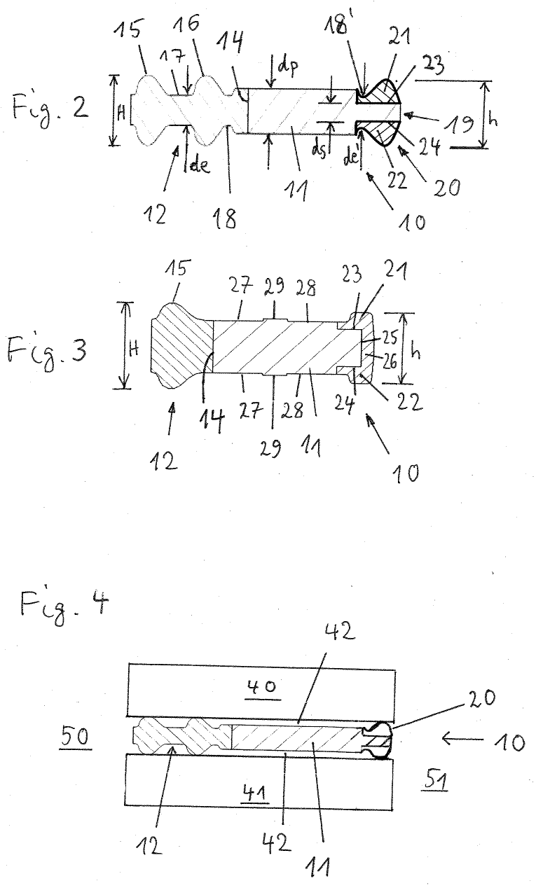

The ring-shaped, static composite seal 10 comprises a profile support 11 made of metal, e.g., aluminum, and a main seal 12 made of elastomer, which main seal is only schematically indicated in FIG. 1. In the mounted state (see FIG. 3), the composite seal 10 is arranged between two housing parts 40, 41 fastened to one another, e.g., by means of screws, and serves to seal a housing interior space 50 from an exterior space 51-for example, the atmosphere. Holes 13 for fastening elements such as screws are preferably provided along the profile support 11. One possible application is that of housings in the drive train of electrically powered motor vehicles—for example, sealing pulse inverters or transmission housings.

An embodiment of the main seal 12 in cross-section is shown, for example, in FIG. 2. The main seal 12 is connected, in particular vulcanized, to the end face 14, facing the interior space 50, of the profile support 11. In this embodiment, a plurality of sealing beads 15, 16, e.g., two, are provided, which are radially offset in the plane of the main seal and each form a sealing edge towards both housing parts 40, 41. Relief grooves 17, 18 are preferably provided between the sealing beads 15, 16 and/or between the sealing bead 16 and the profile support 11. At the position of the relief grooves 17, 18, the thickness de of the main seal 12 is preferably less than the thickness dp of the profile support 11.

The thickness of the profile support 11 corresponds to the gap size between the two mounted housing parts 40, 41; the profile support 11 is screwed onto the block. In the mounted state (see FIG. 4), a gap 42 can nevertheless occur between the profile support 11 and the two housing parts 40, 41 at least in portions on both sides due to tolerances, unevenness, and component deformation. The profile support 11 serves both to shape the main seal 12 connected thereto and to limit the sealing compression of the main seal

In order to prevent dirty water from penetrating from the exterior space 51 into the gap 42 between the profile support 11 and the two housing parts 40, 41, an additional elastomeric profile seal 20 is connected to the exterior side 19, facing the outside space 51, of the profile support 11, which profile seal 20 seals the gap 42 between the profile support 11 and the two housing parts 40, 41 against the outside. The additional profile seal 20 preferably has two sealing elements 21, 22, viz., on each of the two sealing sides of the profile support 11, one sealing element 21, 22 for sealing a gap 42 towards the corresponding housing part 40, 41. As in FIG. 2, these may be separate sealing elements 21, 22.

Since the additional profile seal 20 only performs a protective function against the outside, the height h thereof can preferably be less than the height H of the main seal 12 (in the unloaded state). In order to nevertheless be able to provide a sufficient elastomer sealing height of the additional seal 20, the profile support 11 preferably has recesses 23, 24 on the exterior side 19 thereof, viz., one recess 23, 24 each for a sealing element 21, 22. A sealing element 21, 22 is arranged in a recess 23, 24 and connected to the profile support 11. Due to the recesses 23, 24, the thickness ds of the profile support 11 on the exterior side 19 thereof is at least 10%, preferably at least 20%, less than the thickness dp thereof in the unweakened central region between the main seal 12 and the additional seal 20. The recesses 23, 24 thus allow the additional profile seal 20 to be applied at or below the level of the profile support 11.

Because the profile support 11, for the defined pressing of the main seal 12, in the mounted state, advantageously lies on a block, elastomer in the central region of the profile support 11 could cause interference. The central region of the profile support 11 between the main seal 12 and the additional seal 20 is therefore preferably elastomer-free.

The additional profile seal 20 can also have a relief groove 18′. At the position of the relief groove 18′, the thickness de' of the additional profile seal 12 is preferably less than the thickness dp of the profile support 11.

In the embodiment according to FIG. 3, the sealing elements 21 and 22 are connected to one another by means of an elastomer bridge 26 running over the external end face 25 of the profile support 11. This can be advantageous from a manufacturing point of view. Due to a more compact design of the main seal 12 without constrictions 17, 18 compared to FIG. 2, a sealing bead 15 for the main seal 12 may be sufficient, which sealing bead 15 forms only one sealing edge towards both housing parts 40, 41, which saves space.

In the elastomer-free region between the main seal 12 and the additional profile seal 20, the profile support can have at least one, preferably two, embossed portions 27, 28, which are created by the vulcanization tool, advantageously again towards both housing parts 40, 41. The embossed portions 27, 28 are formed on both sides of a central portion 29 and have a reduced height compared to the latter. By means of these embossed portions 27, 28, additional relief space can be created for the main seal 12 and/or for the additional profile seal 20.

As can be seen from FIGS. 2 and 3, the composite seal 10 can be constructed mirror-symmetrically with respect to a center plane, running in the ring plane, of the composite seal 10.

As shown in FIG. 1, the circumferential profile support 11 advantageously consists of several, e.g., two, support parts 30, 31, which are connected to one another only by the elastomer of the main seal 12 (inside) and/or the elastomer of the additional profile seal 20 (outside). A gap 32 is thus formed between the support parts 30, 31. Each support part 30, 31 forms a circumferential portion of the profile support 11, wherein all support parts 30, 31 complement one another to form the profile support. This embodiment has the advantage that the ring-shaped profile support does not have to be punched as a whole, but only the individual support parts 30, 31 with a considerably smaller surface area, which saves considerable punching waste.

The gap 32 running between the support parts 30, 31 preferably runs non-linearly, in particular in an S-shape, with a central portion 33, running parallel to the ring axis or to the circumference of the profile support 11, and two end portions 34, 35 each extending in opposite directions from the central portion 33. This shape of the gap 32 has the advantage that the connection of the support parts 30, 31 to one another is stronger than in the case of a gap without a central portion 33. The central portion 33 is advantageously longer, preferably at least twice as long, as the length of each end portion 34, 35.

### LIST OF REFERENCE SIGNS

10 composite seal

11 profile support

12 main seal

13 holes

14 end face

15, 16 sealing bead

17, 18 relief groove

19 exterior side

20 additional profile seals

21, 22 sealing elements

23, 24 recess

25 end face

26 elastomer bridge

27, 28 embossed portions

29 central portion

30, 31 support parts

32 gap

33 central portion

34, 35 end portion

40, 41 housing part

42 gap

50 interior space

51 exterior space

1. A composite seal for the circumferential sealing of an interior space, formed between two motor vehicle housing parts, against an exterior space, comprising a metallic profile support and an elastomeric main seal which is connected to the profile support at an end face, facing the interior space, of the profile support, wherein an additional elastomeric profile seal is connected to an exterior side, facing the exterior space, of the profile support, which profile seal causes a sealing against the outside.

2. The composite seal according to claim 1, wherein at least one recess is provided in the profile support on the exterior side thereof, in which recess the additional profile seal is arranged.

3. The composite seal according to claim 1, wherein height h of the additional profile seal in the sealing direction is less than the height H of the main seal.

4. The composite seal according to claim 1, wherein the additional profile seal has a sealing element on each of the two sealing sides of the profile support.

5. The composite seal according to claim 4, wherein the additional profile seal has an elastomer bridge running over the external end face of the profile support and connecting the sealing elements to one another.

6. The composite seal according to claim 1, wherein the profile support has at least one embossed portion in an elastomer-free region between the main seal and the additional profile seal.

7. The composite seal according to claim 1, wherein the main seal and/or the additional profile seal has/have at least one relief groove.

8. The composite seal according to claim 1, wherein the main seal has one or more sealing beads acting upon both sides.

9. The composite seal according to claim 1, wherein the circumferential profile support consists of several support parts which are connected to one another only by the elastomer of the main seal and/or the elastomer of the additional profile seal.

10. The composite seal according to claim 9, wherein a gap running between the support parts is non-linear.

11. The composite seal according to claim 10, wherein the non-linear gap is S-shaped.

12. The composite seal according to claim 6, wherein the profile support has two embossed portions.
